(19) United States
(12) Patent Application Publication
(10) Pub. No.: US 2012/0021831 A1
(43) Pub. Date: Jan. 26, 2012

(54) GAMING SYSTEM, METHOD OF GAMING AND A SOUND CONTROLLER

(75) Inventor: Michael Allan Shai-Hee, Kingsgrove (AU)

(73) Assignee: Aristocrat Technologies Australia PTY Limited, North Ryde (AU)

(21) Appl. No.: 13/247,776

(22) Filed: Sep. 28, 2011

Related U.S. Application Data
(63) Continuation of application No. 12/196,795, filed on Aug. 22, 2008.

(30) Foreign Application Priority Data
Aug. 23, 2007 (AU) 2007904572

(51) Int. Cl. A63F 13/00

(52) U.S. Cl. 463/35

(57) ABSTRACT

A method of providing sound to accompany a game, the method comprising: outputting a game accompanying sound derived from a plurality of sounds associated with respective ones of a plurality of objects to compete in a competition; and modifying the contribution of sounds to the game accompanying sound based on the relative positions in the competition of the objects with which the sounds are associated.

### CROSS-REFERENCE TO RELATED APPLICATIONS

The present application claims the benefit of priority as a continuation to U.S. patent application Ser. No. 12/196,795, filed on Aug. 22, 2008, entitled “Gaming System, Method of Gaming and a Sound Controller”, and to Australian Provisional Patent Application No. 2007904572, filed on Aug. 23, 2007, entitled “Gaming System, Method of Gaming and a Sound Controller”, each of which is herein incorporated by reference in its entirety.

### FIELD

The present invention relates to a gaming system, a method of gaming and a sound controller.

### BACKGROUND

In some games, a player is asked to select an object from many objects to compete in a race. For example, a horse in a horse race. Each horse is displayed as a visual image on the display. The horses then “compete” in a race and a player can see what is happening in the race and determine whether their horse is winning Typically, movements are determined based on random numbers so that a random horse wins. It is also known to adjust the odds of individual horses in such a race.

While such races provide a visual cue to what is happening, we have determined that it would also be desirable to provide an auditory cue as additional feedback to a player.

### SUMMARY OF THE INVENTION

In a first aspect, the invention provides a method of providing sound to accompany a game, the method including:
outputting a game accompanying sound derived from a plurality of sounds associated with respective ones of a plurality of objects to compete in a competition; and
modifying the contribution of sounds to the game accompanying sound based on the relative positions in the competition of the objects with which the sounds are associated.

In an embodiment, the method includes outputting an initial game accompanying sound including contributions from each sound.

In an embodiment, the contributions from each sound are initially equal.

In an embodiment, the contributions of each sound correspond to the odds of the associated object winning the competition.

In an embodiment, the method includes outputting a final game accompanying sound consisting primarily of the sound associated with the winning object.

In an embodiment, the method includes outputting a final game accompanying sound consisting primarily of the sound associated with the objects of a designated number of place getters in the competition.

In an embodiment, the method includes deriving the game accompanying sound based on the sounds of the top three place getters.

In an embodiment, the competition is a race.

In an embodiment, the game accompanying sound is based on the current relative position of the objects in the race.

In an embodiment, the game accompanying sound is based on the proximity of the objects to a finish of the race.

In an embodiment, the objects are selected from the group of: vehicles, boats, aircraft, people, and animals.

In an embodiment, the method includes modifying the contribution of sounds by adjusting their volume relative to other sounds.

In an embodiment, the method includes incorporating at least one background sound in the game accompanying sound.

In an embodiment, there is a sound for each object.

In an embodiment, the plurality of sounds are compatible with one another.

In a second aspect, the invention provides a sound controller for a gaming system, the sound controller arranged to:
output a game accompanying sound signal derived from a plurality of sounds associated with respective ones of a plurality of objects to compete in a competition; and
modify the contribution of sounds to the game accompanying sound signal based on the relative position in the competition of the object with which they are associated.

In an embodiment, the sound controller is arranged to output an initial game accompanying sound signal including contributions from each sound.

In an embodiment, the contributions from each sound are initially equal.

In an embodiment, the contributions of each sound correspond to the odds of the associated object winning the competition.

In an embodiment, the sound controller is arranged to output a final game accompanying sound signal consisting primarily of the sound associated with the winning object.

In an embodiment, the sound controller is arranged to output a final game accompanying sound signal consisting primarily of the sound associated with the objects of a designated number of place getters in the competition.

In an embodiment, the sound controller is arranged to derive the game accompanying sound signal based on the sounds of the top three place getters.

In an embodiment, the competition is a race and the sound controller is arranged to derive the game accompanying sound signal based on the current relative position of the objects in the race.

In an embodiment, the sound controller is arranged to derive the game accompanying sound signal based on the proximity of the objects to a finish of the race.

In an embodiment, the sound controller is arranged to modify the contribution of sounds by adjusting their volume relative to other sounds.

In an embodiment, the sound controller is arranged to incorporate at least one background sound in the game accompanying sound.

In an embodiment, there is a sound for each object.

In an embodiment, the plurality of sounds are compatible with one another.

In a third aspect, the invention provides a gaming system including:
at least one speaker; and
a sound controller arranged to:
   output a game accompanying sound signal to the at least one speaker, the game accompanying sound signal derived from a plurality of sounds associated with respective ones of a plurality of objects to compete in a competition; and
   modify the contribution of sounds to the game accompanying sound signal based on the relative position in the competition of the object with which they are associated.

In an embodiment, the gaming system further includes a display for displaying the competition.

In an embodiment, the gaming system further includes a game controller arranged to determine the positions of the objects in the competition.

In an embodiment, the sound controller is arranged to output an initial game accompanying sound signal including contributions from each sound.

In an embodiment, the contributions from each sound are initially equal.

In an embodiment, the contributions of each sound correspond to the odds of the associated object winning the competition.

In an embodiment, the sound controller is arranged to output a final game accompanying sound signal consisting primarily of the sound associated with the winning object.

In an embodiment, the sound controller is arranged to output a final game accompanying sound signal consisting primarily of the sound associated with the objects of a designated number of place getters in the competition.

In an embodiment, the sound controller is arranged to derive the game accompanying sound signal based on the sounds of the top three place getters.

In an embodiment, the competition is a race and the sound controller is arranged to derive the game accompanying sound signal based on the current relative position of the objects in the race.

In an embodiment, the sound controller is arranged to derive the game accompanying sound signal based on the proximity of the objects to a finish of the race.

In an embodiment, the sound controller is arranged to modify the contribution of sounds by adjusting their volume relative to other sounds.

In an embodiment, the sound controller is arranged to incorporate at least one background sound in the game accompanying sound.

In an embodiment, there is a sound for each object.

In an embodiment, the plurality of sounds are compatible with one another.

In a fourth aspect, the invention provides computer program code which when executed implements the above method.

In a fifth aspect, the invention provides a computer readable medium including the computer program code.

In a sixth aspect, the invention provides a data signal including the computer program code.

In a seventh aspect, the invention extends to transmitting the computer program code.

### BRIEF DESCRIPTION OF THE DRAWINGS

Certain embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a schematic diagram of a networked gaming system;

FIG. 6 is a further block diagram of a gaming system; and

FIG. 7 is a flowchart of an embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Referring to the drawings, there is shown a gaming system arranged to conduct a game involving a competition between objects. Each object has an associated sound. The sounds are combined to form a game accompanying sound. The contributions of individual sounds to the game accompanying sound are varied based on the position of their object in the competition.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

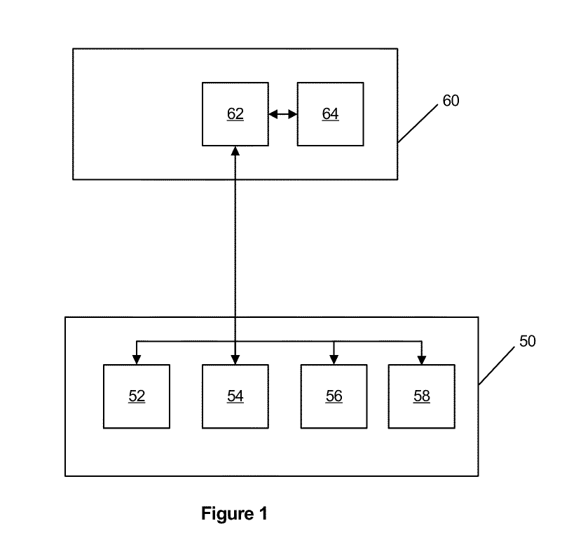

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions and one or more speakers 58 for outputting sound.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

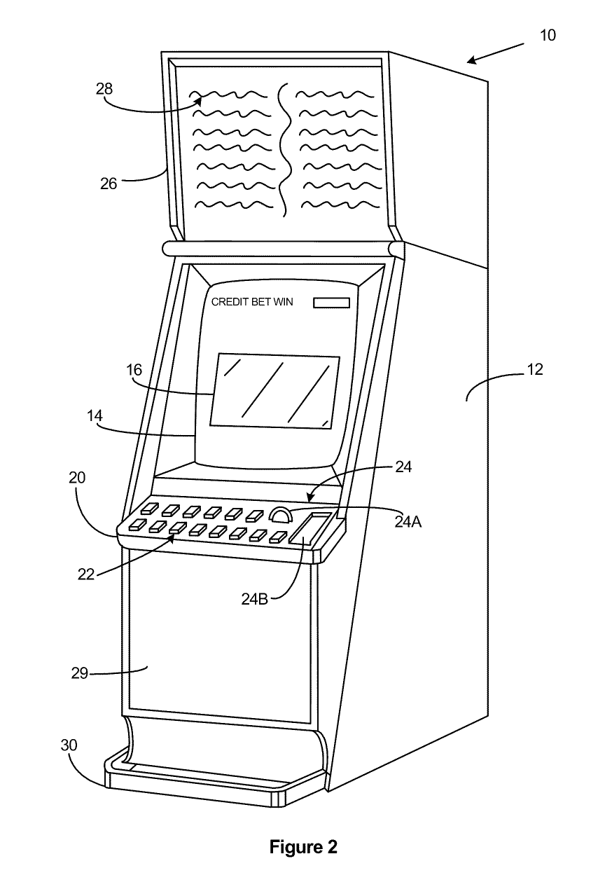

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. Displays of the embodiment are fitted with a touch screen. The top box 26 may also include a display, for example a video display unit, which may be of the same type as the display 14, or of a different type.

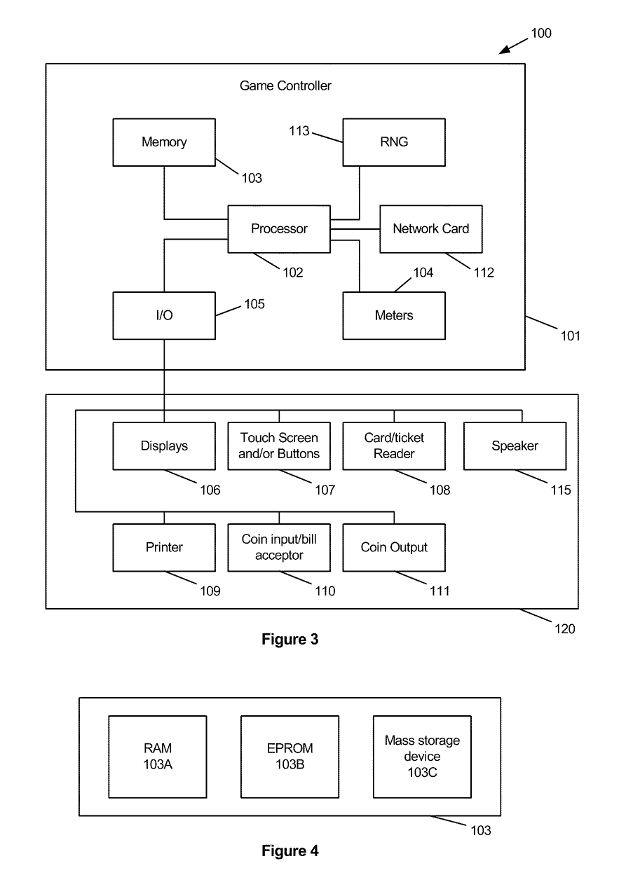

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110, a speaker 115 and a coin output mechanism 111. Additional hardware may be included as part of the gaming machine 100, or hardware may be omitted depending upon the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111,115 to be provided remotely from the game controller 101.

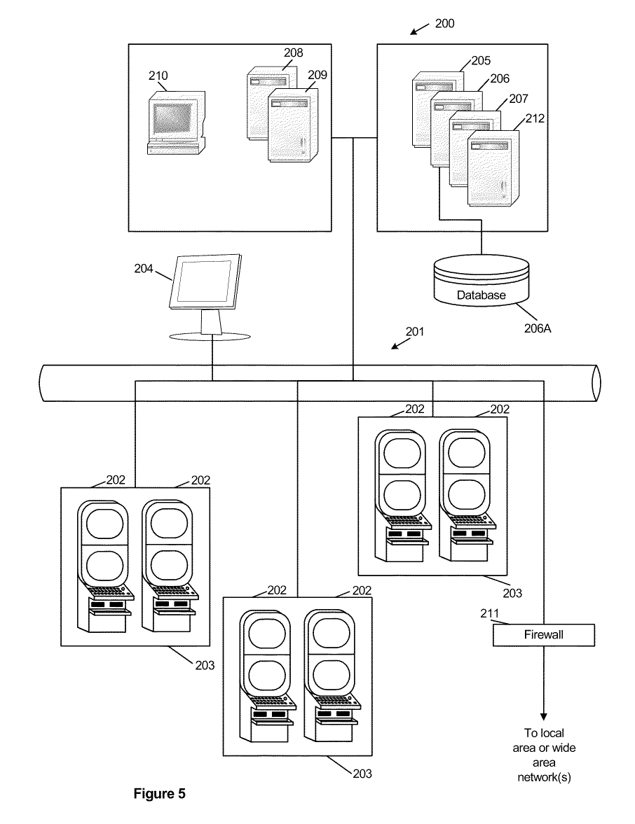

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. A loyalty system 212 may also form part of the gaming network 200.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

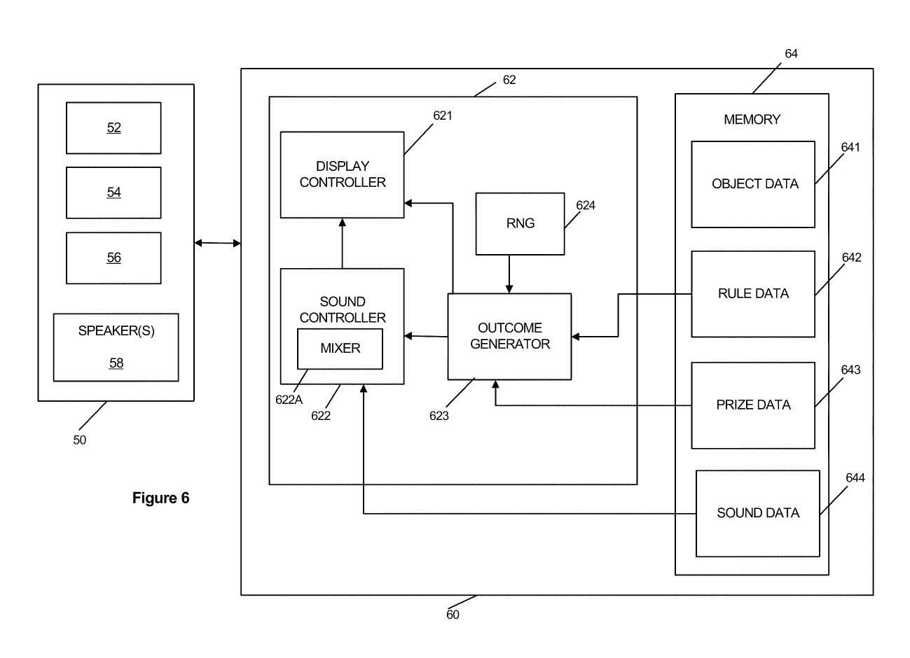

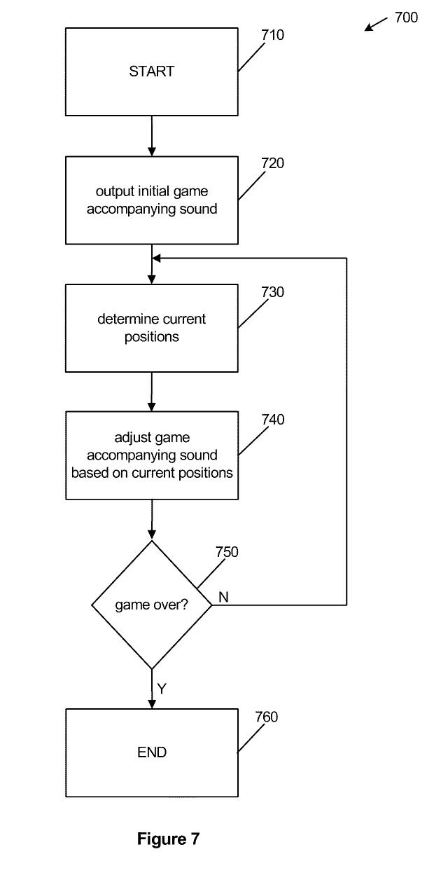

A gaming system is shown in more detail in FIG. 6. The processor 62 of the game controller 60 implements a plurality of modules 621, 622, 623 and 624 by executing program code stored in memory 64. Persons skilled in the art will appreciate that these modules can be implemented in other ways. For example, the random number generator module 624 can be provided by a dedicated hardware circuit independent of the processor 62 or by a random number generator server.

In the embodiment, the competition between objects is implemented as a racing game where animated objects race across terrain on display 54. The appearance of the objects on the display 54 is animated by display controller 621 based on object data 641 which describes the individual objects and how they may move.

The racing game may be provided as a feature game. For example, on a slot machine type game once a particular symbol combination is awarded, a feature game may be triggered where a user gets to select an object to participate in the race (or an object is selected for the user). The outcome generator 623 conducts the race in accordance with known techniques. For example, depending on rule data 642, the outcome generator may determine how far each object is to move in each of a series of rounds by obtaining a value from the random number generator 624 and matching it to a table of movements in the rule data 642. Alternatively, each object may move by a fixed amount and the outcome generator may use the random number generator 624 to determine which object is to move. Other variations will be apparent to persons skilled in the art. Once the movements have been determined, they are displayed on display 54 under control of the display controller 621.

In addition to the visual display of the objects, sound is provided via speaker 58 under control of the sound controller 622. The sound controller processes outcomes to determine how sound data 644 should be mixed by mixer 622a to produce a game accompanying sound. In the embodiment, the mixer 622a is adapted to process input sounds for each object of a plurality of objects that compete in the race by applying a weighting to the sounds based at least in part on the relative positions of the objects in the race. For example, initially the contribution of the sounds from each object are the same but as the race progresses, the sounds are varied based on the relative positions of the objects in the race. A further factor, used by the sound controller in controlling the weightings applied by the mixer 622a may be the proximity of the objects to the end of the race. In the embodiment, greater emphasis is given to the leading objects as the race nears its conclusion. For example, by applying weightings derived from proximity to the finish. Persons skilled in the art will appreciate that numerous objects can be represented on the display. For example, vehicles, aircraft, boats, people or animals.

The method 700 of the embodiment is summarised in FIG. 700. The game starts 710 and an initial game accompanying sound is output 720. The current positions are determined 730 and an adjustment 740 made to the sound 740. If the game is not over 750 the process of determining the current position 730 and adjusting the sound 740 is repeated until ultimately the game ends 760.

Persons skilled in the art will appreciate that an object's “sound” can be made up in a number of ways, for example a series of notes that form a musical tune or be a set of sounds that are output at different times during the game. The sound also need not be musical. For example, animal characters in a race could make animal noises and could make different sounds at different times of a race. Further, persons skilled in the art will appreciate that the game accompanying sound can be derived such that initially only a portion of each sound can be perceived. Further, sounds of different objects may share common elements, e.g. notes. In some embodiments, there may be one or more background sounds added to the individual sounds.

Persons skilled in the art will also appreciate that the sound can be adjusted in a number of ways, for example by adjusting reverberation, delay, equalisation or chorusing.

### EXAMPLE

In a racing game, a player selects a character that he/she believes will win the race. The character could be, for example, an animal, a car or a runner competing on a track. An initial sound may be made when the character is selected which is different to the tune the character makes during the race. For example a parrot may make a “squawking” sound when selected and a “flapping” sound during a race.

A number of tunes are played simultaneously, each tune representing a character in the race. In this example, the tunes are designed to fit together, however in other examples, the tunes may initially be discordant and become more tuneful as a clear winning tune is discerned. The number of tunes played is equal to the number of characters in the race.

To distinguish which tune belongs to which character, at the start of the feature, each tune is played on its own in conjunction with its associated character being displayed on the display.

As the race begins, the tunes are played simultaneously at equal volume. As the race progresses, the tune of the character closest to the finishing line becomes more prominent while the tunes of the others are faded. Eventually at the end of the race, only the tune of the winning character will be heard and the tunes of the other characters are not heard.

In other embodiments it may be possible to hear a tune that is combined based on the place getters. For example, 60% to the winning character, 30% to the next character and 10% to the third character. In other embodiments, a plurality of objects may race but only a subset of the objects which are deemed active may contribute to the sound—for example, only objects associated with a player. In other embodiments, the contribution of a sound may be adjusted or initially set based on the odds of the associated object winning the race.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. As noted above, certain embodiments of the present invention may be implemented using an existing computer processor and/or by a special purpose computer processor incorporated for this or another purpose or by a hardwired system, for example.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A method of providing sound to accompany a game, the method comprising:
outputting a game accompanying sound derived from a plurality of sounds associated with respective ones of a plurality of objects to compete in a competition; and
modifying the contribution of sounds to the game accompanying sound based on the relative positions in the competition of the objects with which the sounds are associated.

2. A method as claimed in claim 1, comprising outputting an initial game accompanying sound comprising contributions from each sound.

3. A method as claimed in claim 2, wherein the contributions from each sound are initially equal.

4. A method as claimed in claim 2, wherein the contributions of each sound correspond to the odds of the associated object winning the competition.

5. A method as claimed in claim 1, comprising outputting a final game accompanying sound consisting primarily of the sound associated with the winning object.

6. A method as claimed in claim 1, comprising outputting a final game accompanying sound consisting primarily of the sound associated with the objects of a designated number of place getters in the competition.

7. A method as claimed in claim 6, comprising deriving the game accompanying sound based on the sounds of the top three place getters.

8. A method as claimed in claim 1, wherein the competition is a race.

9. A method as claimed in claim 8, wherein the game accompanying sound is based on the current relative position of the objects in the race.

10. A method as claimed in claim 9, wherein the game accompanying sound is based on the proximity of the objects to a finish of the race.

11. A method as claimed in claim 8, wherein the objects are selected from the group of: vehicles, boats, aircraft, people, and animals.

12. A method as claimed in claim 1, comprising modifying the contribution of sounds by adjusting their volume relative to other sounds.

13. A method as claimed in claim 1, comprising incorporating at least one background sound in the game accompanying sound.

14. A method as claimed in claim 1, wherein there is a sound for each object.

15. A method as claimed in claim 1, wherein the plurality of sounds are compatible with one another.

16. A sound controller for a gaming system, the sound controller arranged to:
output a game accompanying sound signal derived from a plurality of sounds associated with respective ones of a plurality of objects to compete in a competition; and
modify the contribution of sounds to the game accompanying sound signal based on the relative position in the competition of the object with which they are associated.

17. A sound controller as claimed in claim 16, arranged to output an initial game accompanying sound signal comprising contributions from each sound.

18. A sound controller as claimed in claim 17, wherein the contributions from each sound are initially equal.

19. A sound controller as claimed in claim 17, wherein the contributions of each sound correspond to the odds of the associated object winning the competition.

20. A sound controller as claimed in claim 16, arranged to output a final game accompanying sound signal consisting primarily of the sound associated with the winning object.

21. A sound controller as claimed in claim 16, arranged to output a final game accompanying sound signal consisting primarily of the sound associated with the objects of a designated number of place getters in the competition.

22. A sound controller as claimed in claim 21, arranged to derive the game accompanying sound signal based on the sounds of the top three place getters.

23. A sound controller as claimed in claim 16, wherein the competition is a race and the sound controller is arranged to derive the game accompanying sound signal based on the current relative position of the objects in the race.

24. A sound controller as claimed in claim 23, arranged to derive the game accompanying sound signal based on the proximity of the objects to a finish of the race.

25. A sound controller as claimed in claim 16, arranged to modify the contribution of sounds by adjusting their volume relative to other sounds.

26. A sound controller as claimed in claim 16, arranged to incorporate at least one background sound in the game accompanying sound.

27. A sound controller as claimed in claim 16, wherein there is a sound for each object.

28. A sound controller as claimed in claim 16, wherein the plurality of sounds are compatible with one another.

29. A gaming system comprising:
at least one speaker; and
a sound controller arranged to:
output a game accompanying sound signal to the at least one speaker, the game accompanying sound signal derived from a plurality of sounds associated with respective ones of a plurality of objects to compete in a competition; and
modify the contribution of sounds to the game accompanying sound signal based on the relative position in the competition of the object with which they are associated.

30. A gaming system as claimed in claim 29, further comprising a display for displaying the competition.

31. A gaming system as claimed in claim 29, further comprising a game controller arranged to determine the positions of the objects in the competition.

32. A gaming system as claimed in claim 29, wherein the sound controller is arranged to output an initial game accompanying sound signal comprising contributions from each sound.

33. A gaming system as claimed in claim 32, wherein the contributions from each sound are initially equal.

34. A gaming system as claimed in claim 32, wherein the contributions of each sound correspond to the odds of the associated object winning the competition.

35. A gaming system as claimed in claim 29, wherein the sound controller is arranged to output a final game accompanying sound signal consisting primarily of the sound associated with the winning object.

36. A gaming system as claimed in claim 29, wherein the sound controller is arranged to output a final game accompanying sound signal consisting primarily of the sound associated with the objects of a designated number of place getters in the competition.

37. A gaming system as claimed in claim 36, wherein the sound controller is arranged to derive the game accompanying sound signal based on the sounds of the top three place getters.

38. A gaming system as claimed in claim 29, wherein the competition is a race and the sound controller is arranged to derive the game accompanying sound signal based on the current relative position of the objects in the race.

39. A sound controller as claimed in claim 38, wherein the sound controller is arranged to derive the game accompanying sound signal based on the proximity of the objects to a finish of the race.

40. A gaming system as claimed in claim 29, wherein the sound controller is arranged to modify the contribution of sounds by adjusting their volume relative to other sounds.

41. A gaming system as claimed in claim 29, wherein the sound controller is arranged to incorporate at least one background sound in the game accompanying sound.

42. A gaming system as claimed in claim 29, wherein there is a sound for each object.

43. A gaming system as claimed in claim 29, wherein the plurality of sounds are compatible with one another.

44. A computer readable medium including computer program code which when executed implements the method of claim 1.
